(19) United States
(12) Patent Application Publication
(10) Pub. No.: US 2025/0239652 A1
(43) Pub. Date: Jul. 24, 2025

(54) SECONDARY BATTERY

(71) Applicant: MURATA MANUFACTURING CO., LTD., Kyoto (JP)

(72) Inventors: Yoshiaki SUZUKI, Kyoto (JP); Aiko KANAZAWA, Kyoto (JP); Daisuke MORI, Kyoto (JP); Yuri NAKAYAMA, Kyoto (JP)

(21) Appl. No.: 19/174,232

(22) Filed: Apr. 9, 2025

Related U.S. Application Data
(63) Continuation of application No. PCT/JP2023/032774, filed on Sep. 8, 2023.

(30) Foreign Application Priority Data
Dec. 1, 2022 (JP) 2022-193113

(51) Int. Cl. H01M 10/0567; H01M 4/38; H01M 10/054; H01M 10/42

(52) U.S. Cl. CPC H01M 10/0567; H01M 4/381; H01M 10/054; H01M 10/4235; H01M 2300/0025

(57) ABSTRACT

A secondary battery includes a positive electrode, a negative electrode including a magnesium-containing material, and an electrolytic solution including anthracene and 9,10-dihydroanthracene. A ratio of a content of 9,10-dihydroanthracene in the electrolytic solution to a content of anthracene in the electrolytic solution is 0.03 or less. An overvoltage represented by Expression (1) is 0.22 V or less.

$$E = E 1 - E 2 \qquad ( 1 )$$

where:
E is the overvoltage (V) to be measured using a secondary battery for testing including the negative electrode as a test electrode and a nickel plate as a counter electrode;
E1 is an open-circuit voltage (V) when the secondary battery for testing is discharged at a current density of 0.1 mA/cm² until a voltage reaches −2.0 V; and
E2 is a voltage (V) when the secondary battery for testing is charged at a current density of 0.1 mA/cm² until the voltage reaches 2.5 V.

### CROSS REFERENCE TO RELATED APPLICATIONS

The present application is a continuation of International Application No. PCT/JP2023/032774, filed on Sep. 8, 2023, which claims priority to Japanese Patent Application No. 2022-193113, filed on Dec. 1, 2022, the entire contents of which are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. A configuration of the secondary battery has been considered in various ways.

Specifically, in a manufacturing process of a secondary battery including magnesium metal as a negative electrode active material, a surface of the magnesium metal is polished with a piece of abrasive paper. This removes an oxide film formed on the surface of the magnesium metal, and thus allows the surface of the magnesium metal to be activated.

### SUMMARY

The present technology relates to a secondary battery.

Although consideration has been given in various ways regarding a configuration of a secondary battery, a battery characteristic of the secondary battery is not sufficient yet. Accordingly, there is room for improvement in terms of the battery characteristic of the secondary battery.

It is desirable to provide a secondary battery that makes it possible to achieve a superior battery characteristic.

A secondary battery according to an embodiment of the present technology includes a positive electrode, a negative electrode, and an electrolytic solution. The negative electrode includes a magnesium-containing material. The electrolytic solution includes anthracene and 9,10-dihydroanthracene. A ratio of a content of 9,10-dihydroanthracene in the electrolytic solution to a content of anthracene in the electrolytic solution is 0.03 or less. An overvoltage represented by Expression (1) is 0.22 V or less.

$$E = E 1 - E 2 \qquad ( 1 )$$

where:
E is the overvoltage (V) to be measured using a secondary battery for testing including the negative electrode as a test electrode and a nickel plate as a counter electrode;
E1 is an open-circuit voltage (V) when the secondary battery for testing is discharged at a current density of 0.1 mA/cm² until a voltage reaches −2.0 V; and
E2 is a voltage (V) when the secondary battery for testing is charged at a current density of 0.1 mA/cm² until the voltage reaches 2.5 V.

The “magnesium-containing material” described above refers to a material including magnesium as a constituent material. Note that the magnesium-containing material will be described in detail later.

The “overvoltage” is to be measured using the secondary battery for testing (what is called a half cell) including the test electrode (the negative electrode) and the counter electrode (the nickel plate) in place of the secondary battery including the positive electrode and the negative electrode, as described above. Note that a configuration of the secondary battery for testing and a procedure for calculating the overvoltage will be described in detail later.

When the “ratio” is to be calculated, the secondary battery including the positive electrode and the negative electrode may be used, or the above-described secondary battery for testing including the test electrode and the counter electrode may be used. A procedure for calculating the ratio will be described in detail later.

According to the secondary battery of an embodiment of the present technology: the negative electrode includes the magnesium-containing material; the electrolytic solution includes anthracene and 9,10-dihydroanthracene; the ratio of the content of 9,10-dihydroanthracene in the electrolytic solution to the content of anthracene in the electrolytic solution is 0.03 or less; and the overvoltage represented by Expression (1) is 0.22 V or less. Accordingly, it is possible to achieve a superior battery characteristic.

Note that effects of the present technology are not necessarily limited to those described herein and may include any of a series of effects in relation to the present technology.

### BRIEF DESCRIPTION OF THE FIGURES

FIG. 1 is a perspective diagram illustrating a configuration of a secondary battery according to an embodiment of the present technology.

FIG. 2 is a sectional diagram illustrating a configuration of a battery device illustrated in FIG. 1.

FIG. 3 is a sectional diagram illustrating a configuration of a secondary battery for testing.

### DETAILED DESCRIPTION

The present technology is described below in further detail including with reference to the drawings according to an embodiment.

A description is given first of a secondary battery according to an embodiment of the present technology.

The secondary battery described here is a secondary battery that causes charging and discharging reactions to proceed through precipitation and dissolution of magnesium, and is what is called a magnesium secondary battery. In the secondary battery, magnesium is precipitated on and dissolved from a negative electrode, and magnesium is inserted into and extracted from a positive electrode in an ionic state.

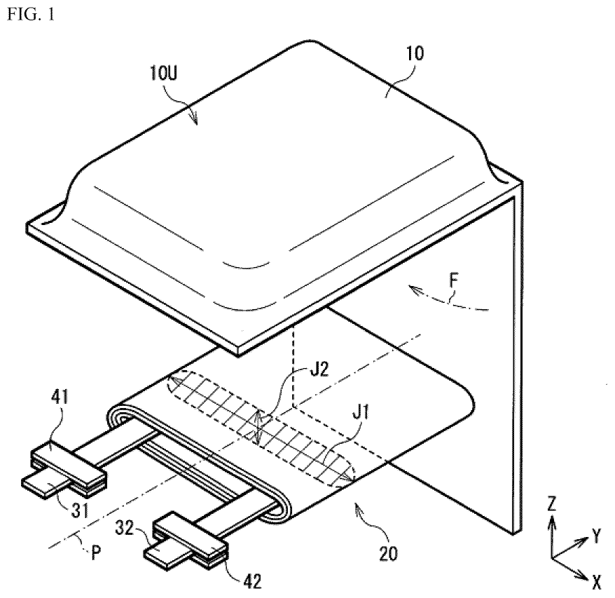

FIG. 1 illustrates a perspective configuration of the secondary battery. FIG. 2 illustrates a sectional configuration of a battery device 20 illustrated in FIG. 1. Note that FIG. 1 illustrates a state where an outer package film 10 and the battery device 20 are separated from each other, and illustrates a section of the battery device 20 along an XZ plane by a dashed line.

As illustrated in FIGS. 1 and 2, the secondary battery includes the outer package film 10, the battery device 20, a positive electrode lead 31, a negative electrode lead 32, and sealing films 41 and 42.

The secondary battery described here includes the outer package film 10 having flexibility or softness as an outer package member as described above, and is thus a secondary battery of what is called a laminated-film type.

As illustrated in FIG. 1, the outer package film 10 has a pouch-shaped structure that is sealed in a state where the battery device 20 is contained inside the outer package film 10. The outer package film 10 thus contains a positive electrode 21, a negative electrode 22, a separator 23, and an electrolytic solution that are to be described later.

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state where the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

The battery device 20 is a power generation device contained inside the outer package film 10. The battery device 20 includes, as illustrated in FIGS. 1 and 2, the positive electrode 21, the negative electrode 22, the separator 23, and the electrolytic solution (not illustrated).

Here, the battery device 20 is what is called a wound electrode body. That is, the positive electrode 21 and the negative electrode 22 are wound about a winding axis P, being opposed to each other with the separator 23 interposed therebetween. As illustrated in FIG. 1, the winding axis P is a virtual axis extending in a Y-axis direction.

A three-dimensional shape of the battery device 20 is not particularly limited. Here, the battery device 20 has an elongated three-dimensional shape. Accordingly, a section of the battery device 20 intersecting the winding axis P, that is, the section of the battery device 20 along the XZ plane, has an elongated shape defined by a major axis J1 and a minor axis J2.

The major axis J1 is a virtual axis that extends in an X-axis direction and has a length larger than a length of the minor axis J2. The minor axis J2 is a virtual axis that extends in a Z-axis direction intersecting the X-axis direction and has a length smaller than the length of the major axis J1. Here, the battery device 20 has an elongated cylindrical three-dimensional shape. Thus, the section of the battery device 20 has an elongated, substantially elliptical shape.

The positive electrode 21 includes, as illustrated in FIG. 2, a positive electrode current collector 21A and a positive electrode active material layer 21B.

The positive electrode current collector 21A is an electrically conductive support that supports the positive electrode active material layer 21B, and has two opposed surfaces on each of which the positive electrode active material layer 21B is to be provided. The positive electrode current collector 21A includes an electrically conductive material such as a metal material. Specific examples of the electrically conductive material include aluminum.

The positive electrode active material layer 21B is supported by the positive electrode current collector 21A, and includes any one or more of positive electrode active materials into which magnesium is to be inserted and from which magnesium is to be extracted. Note that the positive electrode active material layer 21B may further include any one or more of other materials including, without limitation, a positive electrode binder and a positive electrode conductor.

Here, the positive electrode active material layer 21B is provided on each of the two opposed surfaces of the positive electrode current collector 21A. Note, however, that the positive electrode active material layer 21B may be provided only on one of the two opposed surfaces of the positive electrode current collector 21A. A method of forming the positive electrode active material layer 21B is not particularly limited, and specifically includes any one or more of methods including, without limitation, a coating method.

The positive electrode active material is not particularly limited in kind as long as the positive electrode active material is a material into which magnesium is to be inserted and from which magnesium is to be extracted. Specific examples of the positive electrode active material include sulfur, graphite fluoride, a metal oxide, and a metal halide. The metal oxide and the metal halide each include, as one or more constituent elements, any one or more of metal elements including, without limitation, scandium, titanium, vanadium, chromium, manganese, iron, cobalt, nickel, copper, and zinc.

The positive electrode binder includes any one or more of resin materials including, without limitation, a fluorine-based resin, a polyvinyl alcohol-based resin, and a styrene-butadiene copolymer rubber. Specific examples of the fluorine-based resin include polyvinylidene fluoride and polytetrafluoroethylene.

Note that the positive electrode binder may be an electrically conductive polymer compound. Specific examples of the electrically conductive polymer compound include polyaniline, polypyrrole, and polythiophene. A copolymer of any two or more of these electrically conductive polymer compounds may be used. The electrically conductive polymer compound may be unsubstituted, or may be substituted with any one or more of functional groups.

The positive electrode conductor includes any one or more of electrically conductive materials including, without limitation, a carbon material, a metal material, and an electrically conductive polymer compound.

Specific examples of the carbon material include graphite (natural graphite and artificial graphite), a carbon fiber, carbon black, and a carbon nanotube. Examples of the carbon fiber include a vapor-grown carbon fiber (VGCF). Examples of the carbon black include acetylene black and Ketjen black. Examples of the carbon nanotube include a single-walled carbon nanotube (SWCNT) and a multi-walled carbon nanotube (MWCNT). Examples of the multi-walled carbon nanotube include a double-walled carbon nanotube (DWCNT). Specific examples of the metal material include nickel.

The negative electrode 22 includes any one or more of magnesium-containing materials that are negative electrode active materials. The magnesium-containing material is a material including magnesium as a constituent element, as described above.

The magnesium-containing material may be a simple substance of magnesium (what is called magnesium metal), an alloy of magnesium, a compound of magnesium, or a mixture of two or more thereof. Note that purity of the magnesium metal is not particularly limited. The magnesium metal may therefore include any amount of impurity.

One or more metal elements (other than magnesium) included as one or more constituent elements in the alloy of magnesium are not particularly limited in kind as long as the one or more metal elements are any one or more of desired metal elements. The compound of magnesium includes, as one or more constituent elements, any one or more of nonmetal elements including, without limitation, carbon, oxygen, sulfur, and a halogen. Specific examples of the halogen include fluorine, chlorine, bromine, and iodine.

In particular, the negative electrode active material preferably includes the magnesium metal. One reason for this is that this makes it easier to cause the charging and discharging reactions through precipitation and dissolution of magnesium to proceed sufficiently and stably. FIG. 2 illustrates a case where the negative electrode 22 includes the magnesium metal. The magnesium metal may be a magnesium plate or a magnesium foil.

Note that when the magnesium-containing material includes the alloy of magnesium, the compound of magnesium, or both, the negative electrode 22 may have a configuration similar to a configuration of the positive electrode 21. That is, although not specifically illustrated here, the negative electrode 22 may include a negative electrode current collector and a negative electrode active material layer.

The negative electrode current collector is an electrically conductive support that supports the negative electrode active material layer, and has two opposed surfaces on each of which the negative electrode active material layer is to be provided. The negative electrode current collector includes an electrically conductive material such as a metal material. Specific examples of the electrically conductive material include nickel.

The negative electrode active material layer is supported by the negative electrode current collector, and includes any one or more of the magnesium-containing materials. Note that the negative electrode active material layer may further include any one or more of other materials including, without limitation, a negative electrode binder and a negative electrode conductor.

The negative electrode active material layer may be provided on each of the two opposed surfaces of the negative electrode current collector, or may be provided only on one of the two opposed surfaces of the negative electrode current collector. A method of forming the negative electrode active material layer is not particularly limited, and specifically includes any one or more of methods including, without limitation, a coating method.

Details of the negative electrode binder are similar to details of the positive electrode binder. Details of the negative electrode conductor are similar to details of the positive electrode conductor.

The separator 23 is an insulating porous film interposed between the positive electrode 21 and the negative electrode 22 as illustrated in FIG. 2, and allows magnesium to pass therethrough in an ionic state while preventing a short circuit between the positive electrode 21 and the negative electrode 22. The separator 23 includes a polymer compound such as polyethylene.

The electrolytic solution is a liquid electrolyte. The positive electrode 21 and the separator 23 are each impregnated with the electrolytic solution. Note that the negative electrode 22 may also be impregnated with the electrolytic solution. The electrolytic solution includes a solvent, an electrolyte salt, and an additive.

The solvent includes any one or more of non-aqueous solvents (organic solvents), and the electrolytic solution including the one or more non-aqueous solvents is what is called a non-aqueous electrolytic solution. The non-aqueous solvent is not particularly limited in kind; however, the non-aqueous solvent preferably includes an ether compound, in particular. One reason for this is that the electrolyte salt is sufficiently dissolved or dispersed in the non-aqueous solvent.

The ether compound is a compound including an ether bond (—O—). Note that the ether compound may have a chain structure, or may have a cyclic structure. The number of the ether bonds included in the ether compound may be only one, or two or more.

Specific examples of the ether compound include dimethoxyethane, diethylene glycol dimethyl ether, tetraethylene glycol dimethyl ether, and tetrahydrofuran. The foregoing series of specific examples include what is called a glyme-based ether.

The electrolyte salt includes any one or more of magnesium salts. Specific examples of the magnesium salt include magnesium chloride (MgCl₂), magnesium perchlorate (Mg(ClO₄)₂), magnesium nitrate (Mg(NO₃)₂), magnesium sulfate (MgSO₄), magnesium acetate (Mg(CH₃COO)₂), magnesium trifluoroacetate (Mg(CF₃COO)₂), magnesium tetrafluoroborate (Mg(BF₄)₂), magnesium tetraphenylborate (Mg(B(C₆H₅)₄)₂), magnesium hexafluorophosphate (Mg(PF₆)₂), magnesium hexafluoroarsenate (Mg(AsF₆)₂), and magnesium bis(trifluoromethane sulfonyl)imide (Mg [N(CF₃SO₂)₂]₂).

A content (mol/kg) of the electrolyte salt (the magnesium salt) in the electrolytic solution is not particularly limited, and may be set as desired. The content of the electrolyte salt described here is a content of the electrolyte salt with respect to the solvent.

The additive includes anthracene and 9,10-dihydroanthracene. One reason why the additive includes anthracene is that even if the electrolytic solution includes the electrolyte salt (the magnesium salt), electrochemical activity of the electrolytic solution markedly improves.

Specifically, when the electrolytic solution includes the magnesium salt, but does not include anthracene, sufficient electrochemical activity of the electrolytic solution is not obtainable, and in some cases, no electrochemical activity of the electrolytic solution is obtainable.

In contrast, when the electrolytic solution includes anthracene together with the magnesium salt, a structure of a magnesium complex derived from the magnesium salt changes as appropriate, and solubility of magnesium changes as appropriate. This improves an electrochemical characteristic of the electrolytic solution, and thus achieves superior electrochemical activity of the electrolytic solution.

Note that, as described above, while anthracene improves the electrochemical activity of the electrolytic solution, 9,10-dihydroanthracene is formed as a result of anthracene reacting on a surface of the negative electrode 22 (the magnesium-containing material). That is, 9,10-dihydroanthracene is a reaction product formed by presence of the magnesium-containing material having high reactivity. More specifically, 9,10-dihydroanthracene is a compound unintentionally formed by deactivation of anthracene.

Here, anthracene serves to improve the electrochemical activity of the electrolytic solution, as described above. Meanwhile, 9,10-dihydroanthracene is the compound unintentionally formed by deactivation of anthracene, as described above, and therefore does not serve to improve the electrochemical activity of the electrolytic solution.

For such a reason, as will be described later, in a manufacturing process of the secondary battery, the secondary battery after being assembled is subjected to a pre-charging and pre-discharging process to thereby suppress a reaction in which 9,10-dihydroanthracene is formed by deactivation of anthracene, that is, a reaction in which anthracene changes into 9,10-dihydroanthracene. This allows a content of 9,10-dihydroanthracene in the electrolytic solution to be sufficiently small with respect to a content of anthracene in the electrolytic solution.

Specifically, a content ratio C that is a ratio of a content C2 (wt %) of 9,10-dihydroanthracene in the electrolytic solution to a content C1 (wt %) of anthracene in the electrolytic solution is 0.03 or less. One reason for this is that the content C1 is secured, which makes it easier for anthracene to stably and continuously serve to improve the electrochemical activity of the electrolytic solution. The content ratio C is calculated based on the following calculation expression: C=(C2/C1)×100.

A lower limit value of the content ratio C is not particularly limited. Accordingly, the content ratio C may be 0, or may be greater than 0 as long as the content ratio C is 0.03 or less.

A procedure for calculating the content ratio C is as described below. First, the secondary battery is disassembled to thereby collect the electrolytic solution. Thereafter, the electrolytic solution is analyzed by a gas chromatography mass spectrometer (GC-MS) to thereby measure the contents C1 and C2. Lastly, the content ratio C is calculated based on the calculation expression described above.

When the content ratio C is to be calculated, the secondary battery including the positive electrode 21 and the negative electrode 22 may be used as described above, or a secondary battery for testing including a test electrode 51 and a counter electrode 52 may be used. The secondary battery for testing will be described later.

As illustrated in FIGS. 1 and 2, the positive electrode lead 31 is a positive electrode wiring coupled to the positive electrode current collector 21A of the positive electrode 21, and is led to an outside of the outer package film 10. The positive electrode lead 31 includes an electrically conductive material such as a metal material. Specific examples of the electrically conductive material include aluminum. The positive electrode lead 31 has any one of shapes including, without limitation, a thin plate shape and a meshed shape.

As illustrated in FIGS. 1 and 2, the negative electrode lead 32 is a negative electrode wiring coupled to the negative electrode 22, and is led to an outside of the outer package film 10. Note that when the negative electrode 22 includes the negative electrode current collector, the negative electrode lead 32 is coupled to the negative electrode current collector. Here, the negative electrode lead 32 is led in a direction similar to a direction in which the positive electrode lead 31 is led. The negative electrode lead 32 includes an electrically conductive material such as a metal material. Specific examples of the electrically conductive material include copper. Note that details of a shape of the negative electrode lead 32 are similar to those of the shape of the positive electrode lead 31.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry of, for example, outside air into the outer package film 10. The sealing film 41 includes a polymer compound such as a polyolefin that has adherence to the positive electrode lead 31. Specific examples of the polymer compound include polypropylene.

A configuration of the sealing film 42 is similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

The secondary battery operates as below in the battery device 20 according to an embodiment.

Upon discharging, the magnesium-containing material in the negative electrode 22 is dissolved. Accordingly, magnesium is eluted into the electrolytic solution, and the eluted magnesium is inserted into the positive electrode 21. Upon charging, magnesium is extracted from the positive electrode 21 into the electrolytic solution, and the extracted magnesium is precipitated on the negative electrode 22.

In particular, in the secondary battery, the content ratio C is 0.03 or less, and the electrochemical activity of the electrolytic solution thus improves sufficiently, as described above. Accordingly, an overvoltage E of the secondary battery is sufficiently small.

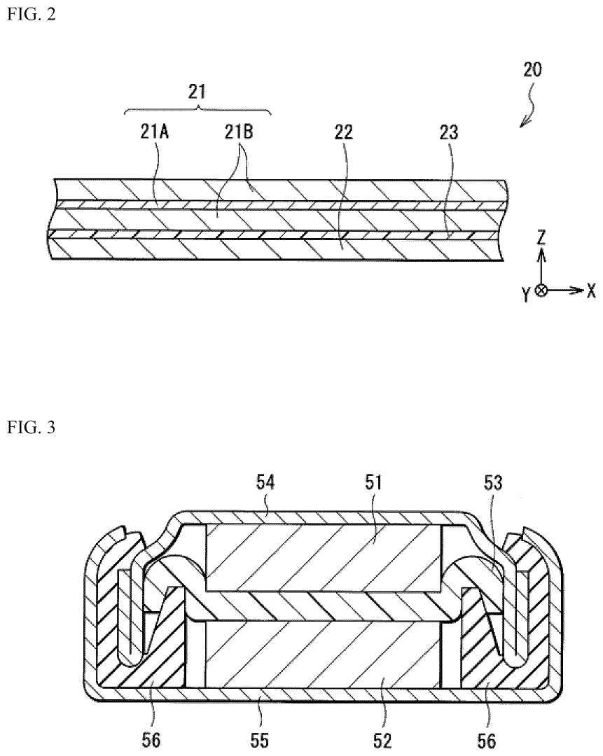

FIG. 3 illustrates a sectional configuration of the secondary battery for testing to be used to measure the overvoltage E. The secondary battery for testing is a magnesium secondary battery of what is called a coin type. More specifically, the secondary battery for testing is a secondary battery (what is called a half cell) that includes the negative electrode 22 as the test electrode 51, and includes, as the counter electrode 52, a nickel plate in place of the positive electrode 21.

A description is given first of a configuration of the secondary battery for testing, and thereafter of a range of the overvoltage E and a procedure for calculating the overvoltage E.

As illustrated in FIG. 3, the secondary battery for testing includes the test electrode 51, the counter electrode 52, a separator 53, an outer package cup 54, an outer package can 55, a gasket 56, and the electrolytic solution (not illustrated).

The test electrode 51 is placed in the outer package cup 54, and the counter electrode 52 is placed in the outer package can 55. The test electrode 51 and the counter electrode 52 are stacked on each other with the separator 53 interposed therebetween, and the test electrode 51, the counter electrode 52, and the separator 53 are each impregnated with the electrolytic solution. The configuration of the electrolytic solution is as described above. The outer package cup 54 and the outer package can 55 are crimped to each other by the gasket 56. Thus, the test electrode 51, the counter electrode 52, and the separator 53 are sealed in the outer package cup 54 and the outer package can 55.

A configuration of the test electrode 51 is similar to the configuration of the negative electrode 22. The counter electrode 52 is the nickel plate. A thickness of the nickel plate is not particularly limited, and may be set as desired. Note that when the test electrode 51 includes the negative electrode current collector and the negative electrode active material layer, the negative electrode active material layer is provided on one side of the negative electrode current collector, and the negative electrode active material layer is provided to be opposed to the counter electrode 52 with the separator 53 interposed therebetween.

The overvoltage E is measured using the secondary battery for testing. Specifically, the overvoltage E represented by Expression (1) is 0.22 V or less. One reason for this is that a battery capacity increases.

$$E = E 1 - E 2 \qquad ( 1 )$$

where:
E is the overvoltage (V) to be measured using the secondary battery for testing including the negative electrode 22 as the test electrode 51 and the nickel plate as the counter electrode 52;
E1 is an open-circuit voltage (V) when the secondary battery for testing is discharged at a current density of 0.1 mA/cm² until a voltage reaches-2.0 V; and
E2 is a voltage (V) when the secondary battery for testing is charged at a current density of 0.1 mA/cm² until the voltage reaches 2.5 V.

The procedure for calculating the overvoltage E with use of the secondary battery for testing is as described below.

First, the secondary battery for testing is discharged to thereby measure the voltage E1 of the secondary battery for testing. In this case, the secondary battery for testing is discharged at the current density of 0.1 mA/cm² until the voltage reaches-2.0 V. Note, however, that when the voltage does not reach-2.0 V upon discharging, the discharging may be stopped at a point in time at which the battery capacity reaches 1 mAh.

Thereafter, the secondary battery for testing is charged to thereby measure the voltage E2 of the secondary battery for testing. In this case, the secondary battery for testing is charged at the current density of 0.1 mA/cm² until the voltage reaches 2.5 V.

Lastly, the overvoltage E is calculated based on the calculation expression represented by Expression (1).

Note that when a secondary battery (the secondary battery including the positive electrode 21 and the negative electrode 22) other than the secondary battery for testing (the secondary battery including the test electrode 51 and the counter electrode 52) is obtained to thereby check the overvoltage E of the secondary battery, the secondary battery for testing is fabricated using the secondary battery. In this case, the secondary battery is disassembled to thereby collect the negative electrode 22, following which the secondary battery for testing is fabricated using the negative electrode 22 as the test electrode 51. Details of a procedure for fabricating the secondary battery for testing will be described later.

When the secondary battery is to be manufactured, the positive electrode 21 and the negative electrode 22 are prepared, and the electrolytic solution is prepared, following which the secondary battery is assembled using the positive electrode 21, the negative electrode 22, and the electrolytic solution, and the pre-charging and pre-discharging process is performed on the assembled secondary battery, in accordance with the following example procedure.

A description is given of a case where the magnesium metal is used as the magnesium-containing material.

First, a positive electrode mixture is obtained by mixing the positive electrode active material, the positive electrode binder, and the positive electrode conductor with each other, following which the positive electrode mixture is put into a solvent to thereby prepare a positive electrode mixture slurry in paste form. The solvent may be an aqueous solvent, or may be an organic solvent. Thereafter, the positive electrode mixture slurry is applied on the two opposed surfaces of the positive electrode current collector 21A to thereby form the positive electrode active material layers 21B. Lastly, the positive electrode active material layers 21B may be compression-molded by, for example, a roll pressing machine. In this case, the positive electrode active material layers 21B may be heated. The positive electrode active material layers 21B may be compression-molded multiple times. The positive electrode active material layers 21B are thus formed on the two respective opposed surfaces of the positive electrode current collector 21A. As a result, the positive electrode 21 is fabricated.

The electrolyte salt is put into the solvent, following which the additive (anthracene) is added to the solvent. The electrolyte salt and the additive are each thereby dispersed or dissolved in the solvent. As a result, the electrolytic solution is prepared.

First, the negative electrode 22 (the magnesium metal) is prepared. A magnesium plate is used as the magnesium metal.

Thereafter, the positive electrode lead 31 is coupled to the positive electrode current collector 21A of the positive electrode 21 by a joining method such as a welding method, and the negative electrode lead 32 is coupled to the negative electrode 22 by the joining method such as the welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby form a wound body (not illustrated). Thereafter, the wound body is pressed by, for example, a pressing machine to thereby shape the wound body into an elongated shape. The shaped wound body has a configuration similar to that of the battery device 20 except that the positive electrode 21, the negative electrode 22, and the separator 23 are each not impregnated with the electrolytic solution.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained inside the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by the bonding method such as the thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution, and the battery device 20 that is a wound electrode body is thus formed. Accordingly, the battery device 20 is sealed in the outer package film 10 having the pouch shape. As a result, the secondary battery is assembled.

The pre-charging and pre-discharging process is performed using the assembled secondary battery. Various conditions including, for example, an environment temperature, the number of times of charging and discharging (the number of cycles), and charging and discharging conditions may be set as desired.

One reason why the pre-charging and pre-discharging process is to be performed is that, as compared with when a polishing process is used to activate a surface of the negative electrode 22 (the magnesium-containing material), an oxide film formed on the surface of the negative electrode 22 is removed as appropriate, which makes appropriate a state of the surface of the negative electrode 22 after the removal of the oxide film. Details of the reason described here will be described later.

Thus, a state of the battery device 20 is electrochemically stabilized. As a result, the secondary battery is completed.

According to the secondary battery: the negative electrode 22 includes the magnesium-containing material; the electrolytic solution includes anthracene and 9,10-dihydroanthracene; the content ratio C is 0.03 or less; and the overvoltage E is 0.22 V or less. Accordingly, it is possible to achieve a superior battery characteristic because of the following reasons.

In the magnesium secondary battery that obtains a battery capacity through precipitation and dissolution of magnesium, the oxide film is formed on the surface of the negative electrode 22 (the magnesium-containing material) having high reactivity, which decreases activity of the surface of the negative electrode 22. Accordingly, in order to improve the activity of the surface of the negative electrode 22, it is necessary to remove the oxide film.

A possible method of removing the oxide film is a method of removing the oxide film by physically polishing the surface of the negative electrode 22 with a piece of abrasive paper in the manufacturing process of the secondary battery. However, when the surface of the negative electrode 22 is physically polished, the oxide film is excessively removed to thereby excessively expose the surface of the negative electrode 22 having high reactivity.

When the surface of the negative electrode 22 having high reactivity is excessively exposed, anthracene easily reacts on the surface of the negative electrode 22, which easily forms 9,10-dihydroanthracene derived from anthracene.

In this case, the content ratio C increases. More specifically, the content ratio C becomes larger than 0.03, which decreases the electrochemical activity of the electrolytic solution. Thus, the overvoltage E increases. More specifically, the overvoltage E becomes higher than 0.22 V, which decreases the battery capacity. This makes it difficult to achieve a superior battery characteristic.

In contrast, when the pre-charging and pre-discharging process is performed, as the method of removing the oxide film, on the assembled secondary battery as described above in the manufacturing process of the secondary battery, the surface of the negative electrode 22 is electrochemically processed to thereby electrochemically remove the oxide film. In this case, unlike when the polishing process described above is used, the oxide film is removed as appropriate. This allows the surface of the negative electrode 22 to be in an appropriate state where the surface of the negative electrode 22 has high reactivity.

When the surface of the negative electrode 22 is in the appropriate state where the surface of the negative electrode 22 has high reactivity, a reaction of anthracene is suppressed on the surface of the negative electrode 22, which suppresses formation of 9,10-dihydroanthracene derived from anthracene.

In this case, the content ratio C decreases. More specifically, the content ratio C becomes 0.03 or less, which improves the electrochemical activity of the electrolytic solution. This decreases the overvoltage E. More specifically, the overvoltage E becomes 0.22 V or less. This increases the battery capacity. Accordingly, it is possible to achieve a superior battery characteristic.

In this case, advantages are achieved also in terms of the following points, in particular.

Firstly, when a complicated polishing process is used, the manufacturing process of the secondary battery becomes complicated. In contrast, when the pre-charging and pre-discharging process is used, a simple process only has to be performed in which the assembled secondary battery is charged and discharged. Accordingly, using the pre-charging and pre-discharging process makes it possible to easily achieve a secondary battery having a superior battery characteristic.

Secondly, when the polishing process is used, it is necessary to physically process the surface of the negative electrode 22 in advance in the manufacturing process of the secondary battery, which decreases manufacturing efficiency of the secondary battery. In contrast, when the pre-charging and pre-discharging process is used, the assembled secondary battery only has to be electrochemically processed. Using the pre-charging and discharging process makes it possible to efficiently achieve a secondary battery having a superior battery characteristic.

Thirdly, when the polishing process is used, the degree of the polishing process easily varies. In contrast, when the pre-charging and pre-discharging process is used, variations in the degree of the pre-charging and pre-discharging process are reduced. Using the pre-charging and discharging process thus makes it possible to stably achieve a secondary battery having a superior battery characteristic.

Fourthly, when the polishing process is used, powder of the magnesium metal is generated. The powder of the magnesium metal is a flammable hazardous material. In contrast, when the pre-charging and pre-discharging process is used, the powder of the magnesium metal is not generated. Using the pre-charging and discharging process makes it possible to safely achieve a secondary battery having a superior battery characteristic.

In particular, the magnesium-containing material may include the magnesium metal. This makes it easier to cause the charging and discharging reactions through precipitation and dissolution of magnesium to proceed sufficiently and stably. Accordingly, it is possible to achieve higher effects.

Further, the secondary battery may include a magnesium secondary battery. This makes it possible to obtain a sufficient battery capacity through precipitation and dissolution of magnesium. Accordingly, it is possible to achieve higher effects.

The applications (application examples) of the secondary battery are not particularly limited. The secondary battery used as a power source may serve as a main power source or an auxiliary power source in, for example, electronic equipment and an electric vehicle. The main power source is preferentially used regardless of the presence of any other power source. The auxiliary power source may be used in place of the main power source, or may be switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery pack may include a battery cell, or may include an assembled battery. The electric vehicle is a vehicle that travels with the secondary battery as a driving power source, and may be a hybrid automobile that is additionally provided with a driving source other than the secondary battery. In an electric power storage system for home use, electric power accumulated in the secondary battery serving as an electric power storage source may be utilized for using, for example, home appliances.

### EXAMPLES

A description is given of Examples of the present technology according to an embodiment.

### Example 1 and Comparative Examples 1 to 3

Secondary batteries were manufactured, following which the secondary batteries were each evaluated for a battery characteristic as described below.

### [Manufacturing of Secondary Battery]

The secondary battery for testing (the magnesium secondary battery of the coin type) illustrated in FIG. 3 was fabricated in accordance with the following procedure.

First, a magnesium plate having a circular shape (with a diameter of 16 mm) that was the negative electrode 22 (the magnesium-containing material) was prepared as the test electrode 51, and a nickel plate having a circular shape (with a diameter of 17 mm) was prepared as the counter electrode 52.

Thereafter, an electrolyte salt (lithium chloride and magnesium bis(trifluoromethane sulfonyl)imide) and an additive (anthracene) were added to a solvent (diethylene glycol dimethyl ether as an ether compound), following which the solvent was stirred. The electrolytic solution was thus prepared.

In this case, a content of lithium chloride in the electrolytic solution was 0.4 mol/kg. A content of magnesium bis(trifluoromethane sulfonyl)imide in the electrolytic solution was 0.4 mol/kg. A content of anthracene in the electrolytic solution was 0.01 mol/kg.

Thereafter, the counter electrode 52 was placed inside the outer package can 55, following which two separators 53 were placed on the counter electrode 52. In this case, one separator 53 having a circular shape (a glass fiber filter GC-50 available from Advantec Co., Ltd. having a diameter of 19 mm) was placed on the counter electrode 52, following which another separator 53 having a circular shape (a glass fiber filter GC-50 available from Advantec Co., Ltd. having a diameter of 16 mm) was placed on the one separator 53 having a circular shape.

Thereafter, the electrolytic solution was dropped from above the two separators 53 to thereby impregnate the two separators 53 with the electrolytic solution. In this case, an amount of the dropped electrolytic solution was 200 μl (=200×10⁻⁶ dm³).

Thereafter, the test electrode 51 was placed on the two separators 53, following which the outer package cup 54 was placed on the test electrode 51.

Thereafter, the outer package cup 54 and the outer package can 55 were crimped to each other by the gasket 56 (a polypropylene film). Thus, the test electrode 51 and the counter electrode 52 were sealed in the outer package cup 54 and the outer package can 55. As a result, the secondary battery for testing was assembled.

Lastly, the assembled secondary battery for testing was left standing (for a standing time of 48 hours), following which a pre-charging and pre-discharging process (one cycle of charging and discharging) was performed on the secondary battery for testing. In this case, the secondary battery for testing was discharged at a current density of 0.1 mA/cm² until the voltage reached-2.0 V, following which the secondary battery for testing was charged at a current density of 0.1 mA/cm² until the voltage reached 2.5 V. As a result, the secondary battery for testing was completed (Example 1).

For comparison, the following secondary batteries for testing were fabricated.

Firstly, the secondary battery for testing was fabricated by a similar procedure, except that the pre-charging and pre-discharging process was not performed (Comparative example 1).

Secondly, the secondary battery for testing was fabricated by a similar procedure, except that a polishing process was performed in place of the pre-charging and pre-discharging process (Comparative example 2). In this case, when the test electrode 51 was to be prepared, a wrapping film sheet (#600) was used to polish, by hand, the surface of the test electrode 51 (the magnesium plate) for a polishing time of 5 minutes until a metallic luster was obtained.

Thirdly, the secondary battery for testing was fabricated by a similar procedure, except that the polishing process was further performed (Comparative example 3). The procedure of the polishing process was as described above.

After the completion of the secondary batteries for testing, the content ratio C and the overvoltage E (V) were checked. The results presented in Table 1 were obtained. Note that the procedures for calculating the content ratio C and the overvoltage E were as described above.

### [Evaluation of Battery Characteristic]

The secondary batteries were each evaluated for an operation characteristic as the battery characteristic, and the evaluation revealed the results presented in Table 1.

### [Operation Characteristic]

The secondary battery for testing was repeatedly charged and discharged in an ambient-temperature environment (at a temperature of 23° C.) to thereby measure the battery capacities (mAh) until the secondary battery for testing was short-circuited. An accumulated capacity (mAh) that was an index for evaluating the operation characteristic was thus calculated. When the accumulated capacity was to be calculated, the battery capacities obtained up to the time the secondary battery for testing was short-circuited were accumulated. Note that charging and discharging conditions were similar to the charging and discharging conditions upon the pre-charging and pre-discharging process described above.

TABLE 1

| | | Pre-charging | | | |
|---|---|---|---|---|---|
| | | and | | | Accumulated |
| | Polishing | pre-discharging | Content | Overvoltage E | capacity |
| | process | process | ratio C | (V) | (mAh) |
| Example 1 | Not performed | Performed | ≤0.03 | 0.22 | >9 |
| Comparative example 1 | Not performed | Not performed | ≤0.03 | 2 | 0 |
| Comparative example 2 | Performed | Not performed | >0.03 | 1.6 | 2.6 |
| Comparative example 3 | Performed | Performed | >0.03 | 0.6 | 0.8 |

### DISCUSSION

As indicated in Table 1, the accumulated capacity varied depending on the content ratio C and the overvoltage E.

Specifically, when the content ratio C was 0.03 or less, but the overvoltage E was higher than 0.22 V because neither the polishing process nor the pre-charging and pre-discharging process was performed (Comparative example 1), the secondary battery for testing was not charged and discharged, and the accumulated capacity was therefore not obtained.

In addition, when the content ratio C was larger than 0.03 and the overvoltage E was higher than 0.22 V because the polishing process was performed in place of the pre-charging and pre-discharging process (Comparative example 2), the accumulated capacity decreased.

Further, when the content ratio C was larger than 0.03 and the overvoltage E was higher than 0.22 V because the polishing process and the pre-charging and pre-discharging process were both performed (Comparative example 3), the accumulated capacity markedly decreased.

In contrast, when the content ratio C was 0.03 or less and the overvoltage E was 0.22 V or less because the pre-charging and pre-discharging process was performed in place of the polishing process (Example 1), the accumulated capacity markedly increased.

Based upon the results presented in Table 1, when: the negative electrode 22 included the magnesium-containing material; the electrolytic solution included anthracene and 9,10-dihydroanthracene; the content ratio C was 0.03 or less; and the overvoltage E was 0.22 V or less, a high accumulated capacity was obtained. The operation characteristic therefore improved. Accordingly, the secondary battery achieved a superior battery characteristic.

Although the present technology has been described above with reference to one or more embodiments including Examples, the configuration of the present technology is not limited thereto, and is therefore modifiable in a variety of ways.

For example, the description has been given of the case where the secondary battery has a battery structure of the laminated-film type or the coin type. However, the battery structure of the secondary battery is not particularly limited. The battery structure of the secondary battery may be, for example, of a cylindrical type, a prismatic type, or a button type.

Further, the description has been given of the case where the battery device has a device structure of a wound type; however, the device structure of the battery device is not particularly limited. The device structure may be, for example, of a stacked type or a zigzag folded type. In the stacked type, the positive electrode and the negative electrode are stacked on each other. In the zigzag folded type, the positive electrode and the negative electrode are folded in a zigzag manner.

The effects described herein are mere examples, and effects of the present technology are therefore not limited thereto. Accordingly, the present technology may achieve other effects.

The present technology may have any of the following configurations according to an embodiment.

<1>

A secondary battery including:
a positive electrode;
a negative electrode including a magnesium-containing material; and
an electrolytic solution including anthracene and 9,10-dihydroanthracene, wherein
a ratio of a content of 9,10-dihydroanthracene in the electrolytic solution to a content of anthracene in the electrolytic solution is 0.03 or less, and
an overvoltage represented by Expression (1) is 0.22 volts or less,

$$E = E 1 - E 2 \qquad ( 1 )$$

where
E is the overvoltage in volts to be measured using a secondary battery for testing including the negative electrode as a test electrode and a nickel plate as a counter electrode,
E1 is an open-circuit voltage in volts when the secondary battery for testing is discharged at a current density of 0.1 milliamperes per square centimeter until a voltage reaches-2.0 volts, and
E2 is a voltage in volts when the secondary battery for testing is charged at a current density of 0.1 milliamperes per square centimeter until the voltage reaches 2.5 volts.
   <2>

The secondary battery according to <1>, in which the magnesium-containing material includes magnesium metal.

<3>

The secondary battery according to <1> or <2>, in which the secondary battery includes a magnesium secondary battery.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode including a magnesium-containing material; and
an electrolytic solution including anthracene and 9,10-dihydroanthracene, wherein
a ratio of a content of 9,10-dihydroanthracene in the electrolytic solution to a content of anthracene in the electrolytic solution is 0.03 or less, and
an overvoltage represented by Expression (1) is 0.22 volts or less,
$$E = E 1 - E 2 \qquad ( 1 )$$
where
E is the overvoltage in volts to be measured using a secondary battery for testing including the negative electrode as a test electrode and a nickel plate as a counter electrode,
E1 is an open-circuit voltage in volts when the secondary battery for testing is discharged at a current density of 0.1 milliamperes per square centimeter until a voltage reaches-2.0 volts, and
E2 is a voltage in volts when the secondary battery for testing is charged at a current density of 0.1 milliamperes per square centimeter until the voltage reaches 2.5 volts.

2. The secondary battery according to claim 1, wherein the magnesium-containing material includes magnesium metal.

3. The secondary battery according to claim 1, wherein the secondary battery comprises a magnesium secondary battery.
